(19) United States
(12) Patent Application Publication
(10) Pub. No.: US 2013/0034804 A1
(43) Pub. Date: Feb. 7, 2013

(54) HYBRID POROUS CARBON FIBER AND METHOD FOR FABRICATING THE SAME

(71) Applicants: Soon Hyung HONG, Daejeon (KR); Yong Jin JEONG, Daejeon (KR); Kyong Ho LEE, Daejeon (KR); Chan Bin MO, Daejeon (KR)

(72) Inventors: Soon Hyung HONG, Daejeon (KR); Yong Jin JEONG, Daejeon (KR); Kyong Ho LEE, Daejeon (KR); Chan Bin MO, Daejeon (KR)

(73) Assignee: KOREA ADVANCED INSTITUTE OF SCIENCE AND TECHNOLOGY, Daejeon (KR)

(21) Appl. No.: 13/571,509

(22) Filed: Aug. 10, 2012

Related U.S. Application Data
(63) Continuation-in-part of application No. 12/385,763, filed on Apr. 17, 2009, now abandoned.

(30) Foreign Application Priority Data
Sep. 30, 2008 (KR) 10-2008-0096148

(51) Int. Cl. H01B 1/04; D04H 1/08; H01M 4/96; B82Y 40/00; B82Y 30/00

(52) U.S. Cl. 429/532; 252/502; 428/367; 442/320; 977/742; 977/842; 977/948

(57) ABSTRACT

Disclosed is a hybrid porous carbon fiber and a method for fabrication thereof. Such fabricated porous carbon fibers contain a great amount of mesopores as a porous structure readily penetrable by electrolyte. Accordingly, the hybrid porous carbon fibers of the present disclosure are suitable for manufacturing electrodes with high electric capacity.

### CROSS-REFERENCE TO RELATED APPLICATION

This application is a continuation-in-part of U.S. Ser. No. 12/385,763 filed on Apr. 17, 2009, which claims priority to Korean Patent Application No. 10-2008-0096148, filed on Sep. 30, 2008, in the Korean Intellectual Property Office, the entire contents of which are hereby incorporated by reference.

### FIELD OF THE INVENTION

The present disclosure relates to a hybrid porous carbon fiber and a method for fabricating the same. Such fabricated porous carbon fibers contain a great amount of mesopores as a porous structure readily penetrable by electrolyte. Accordingly, the porous carbon fibers of the present disclosure are suitable for manufacturing electrodes with high electric capacity.

### DESCRIPTION OF THE RELATED ART

A great deal of studies and investigation into electrode materials for supercapacitors are underway and such supercapacitors using activated carbon have been commercially available in Japan since early 1980s. However, such studies substantially presently face technical limitations, while research and development for oxide electrodes are being continued centering around the United States and Japan.

Researches for carbon nanotube composite materials for electrode materials useful for supercapacitors are being actively executed by advanced countries including the United States and Japan. These are mostly directed to use of carbon nanotube itself as an electrode material and/or preparation of carbon nanotube composite materials. Such a carbon nanotube composite material is prepared by mixing carbon nanotubes with activated carbon, which is widely used as an electrode material for a supercapacitor, and/or depositing carbon nanotubes with metal oxides such as RuO₂ or IrO₂ or conductive polymer such as polyaniline.

There are presently active efforts to manufacture electrode materials for an electric double layer type supercapacitor using activated carbon with less cost burden. However, capacitance per unit weight of an electrode made of carbon nanotube composite material is still considerably lower than those of existing metal oxides (700 F/g) and conductive polymer (500 F/g). Accordingly, there is a strong requirement for development of a novel carbon nanotube composite material based electrode using activated carbon with improved capacitance per unit weight thereof.

### SUMMARY OF THE INVENTION

Accordingly, the present disclosure has been proposed to solve conventional problems described above and an object of the present disclosure is to provide a hybrid porous carbon fiber and a method for fabricating the same.

Another object of the present disclosure is to provide uses of the hybrid porous carbon fiber fabricated according to the present disclosure in manufacturing an electrochemical electrode and a supercapacitor.

In order to achieve the above objects of the present disclosure, there is provided a hybrid porous carbon fiber including carbon nanotube-reinforced carbon nanofiber, which contains mesopores having a pore diameter of from about 3 nm to about 10 nm, and has a specific capacitance of about 150 F/g or more.

Further, there is provided a method for fabricating the hybrid porous carbon fibers including: mixing a starch solution, a carbon nanotube-dispersed solution and a spinning agent to obtain a spinning solution of carbon nanotube/starch/spinning agent; spinning the spinning solution to obtaining the starch fiber containing carbon nanotubes; and carbonizing the starch fiber containing carbon nanotubes, wherein the hybrid porous fiber contains mesopores having a pore diameter of from about 3 nm to about 10 nm, and has a specific capacitance of about 150 F/g or more.

According the present disclosure, such fabricated hybrid porous carbon fiber exhibits high specific surface area and excellent electrochemical properties such as high capacitance. The hybrid porous carbon fiber also contains a great amount of mesopores having an average diameter ranging from 3 nm to 10 nm, through which electrolyte is easily penetrated, thereby being favorably used as an electrode material.

### BRIEF DESCRIPTION OF THE DRAWINGS

These and other objects, features, aspects, and advantages of the present disclosure will be more fully described in the following detailed description of preferred embodiments and examples, taken in conjunction with the accompanying drawings. In the drawings:

FIG. 1 is schematic view illustrating an essential concept for a hybrid porous carbon fiber according to the present disclosure.

FIG. 2A is a scanning electron microscopic (SEM) photograph of starch fiber containing carbon nanotubes according to the present disclosure.

FIG. 2B is an enlarged SEM photograph of one of the starch fiber containing carbon nanotubes shown in FIG. 2A.

FIG. 3 is a SEM photograph of the starch fiber web containing carbon nonofibers after stabilization.

FIG. 4A is a SEM photograph of the hybrid porous carbon fibers having highly porous surface.

FIG. 4B is a TEM photograph of the hybrid porous carbon fibers having highly porous surface.

FIG. 5 is a graph illustrating XRD analysis results of graphitized CNT/carbon nanofibers.

FIG. 6A is a graph illustrating FT-IR analysis results of porous CNT/carbon nanofibers heat-treated at 1400° C.

FIG. 6B is a graph illustrating FT-IR analysis results of porous CNT/carbon nanofibers heat-treated at 700° C.

FIG. 6C is a graph illustrating FT-IR analysis results of porous CNT/carbon nanofibers activated at 250° C.

FIG. 7 is a graph illustrating CV curve of porous CNT/carbon nanofibers heat-treated at 1400° C.

FIG. 8A is a graph illustrating specific surface and pore size distribution of CNT/carbon nanofibers activated at 250° C.

FIG. 8B is a graph illustrating CV curve of porous CNT/carbon nanofibers heat-treated at 700° C. and CNT/carbon nanofibers activated at 250° C.

FIG. 9A is a SEM photograph of porous carbon fibers coated with platinum (Pt) nanoparticles.

FIG. 9B is a graph illustrating EDAX analysis results of the porous carbon fibers coated with Pt nanoparticles shown in FIG. 9A.

FIG. 10 is a photograph of CNT/carbon nanofibers electrode and schematic of a cell test method.

### DETAILED DESCRIPTION OF THE INVENTION

Hereinafter, illustrative embodiments and examples of the present disclosure will be described in detail with reference to the accompanying drawings so that the present disclosure may be readily implemented by those skilled in the art.

However, it is to be noted that the present disclosure is not limited to the illustrative embodiments and examples but can be embodied in various other ways. In drawings, parts irrelevant to the description are omitted for the simplicity of explanation, and like reference numerals denote like parts through the whole document.

In accordance with an aspect of the present disclosure, there is provided a hybrid porous carbon fiber comprising carbon nanotube-reinforced carbon nanofiber, which the hybrid porous fiber contains mesopores having a pore diameter of from about 3 nm to about 10 nm, and has a specific capacitance of about 150 F/g or more, but it is not limited thereto.

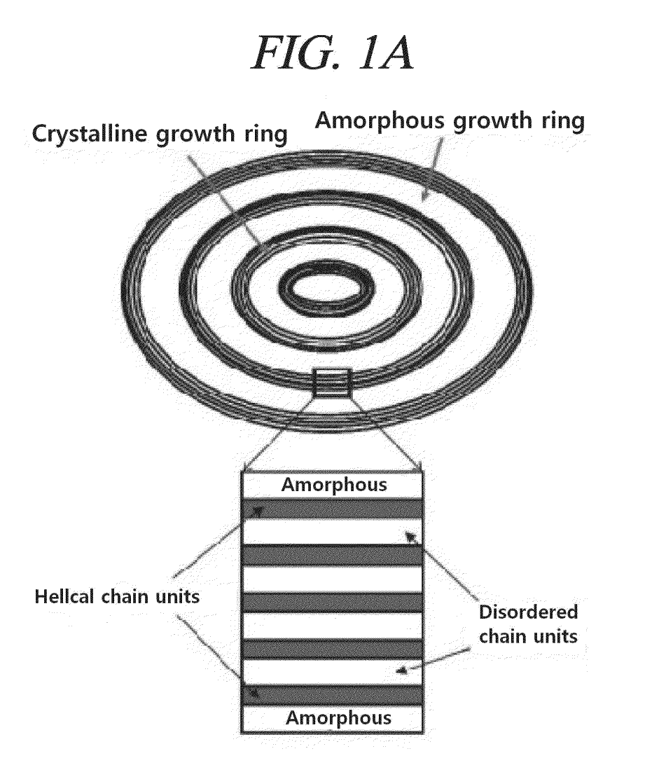

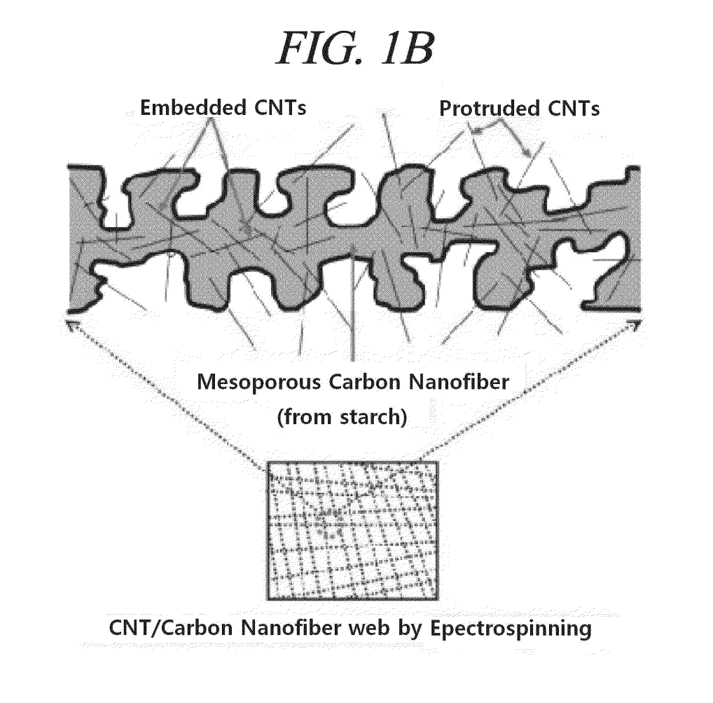

The hybrid porous carbon fiber fabricated as described above is shown in FIG. 1B which is an essential concept diagram illustrating the hybrid porous carbon fiber of the present disclosure.

In accordance with an illustrative embodiment of the present disclosure, the hybrid porous fiber has a specific surface area of from about 300 m²/g to about 500 m²/g and an electrical conductivity of from about 1 S/cm to about 3 S/cm, but it is not limited thereto.

In accordance with an illustrative embodiment of the present disclosure, the hybrid porous fiber is prepared by carbonizing a starch fiber containing carbon nanotubes. For examples, the starch fiber containing carbon nanotubes is carbonized at from about 500° C. to about 1,400° C. under vacuum or an inert gas atmosphere.

In accordance with an illustrative embodiment of the present disclosure, the starch fiber containing carbon nanotubes is prepared by mixing a starch solution, a carbon nanotube-dispersed solution and a spinning agent to obtain a spinning solution of carbon nanotube/starch/spinning agent, and spinning the spinning solution to obtain the starch fiber containing carbon nanotubes, but it is not limited thereto. For examples, the starch fiber containing carbon nanotubes is spun by electro-spinning or wet-state spinning the spinning solution, but it is not limited thereto. A weight ratio of starch included in the starch solution: carbon nanotube included in the carbon nanotube-dispersed solution is about 1: more than 0 to about 1, for example, about 1: about 0.001, about 1: about 0.01, about 1: about 0.1, about 1: about 0.5, or about 1: about 1, but it is not limited thereto.

The spinning agent includes at least one selected from the group consisting of, but not limited to, polyvinyl alcohol, polyethylene oxide, polycarbonate, polylacetic acid, polyvinylcarbazole, polymethacrylate, cellulose acetate, collagen, polycaprolactone and poly(2-hydroxyethyl methacrylate). A weight ratio of the starch: the spinning agent is about 1: more than 0 to about 1, for examples, about 1: about 0.001, about 1: about 0.01, about 1: about 0.1, about 1: about 0.5, but it is not limited thereto.

In accordance with another aspect of the present disclosure, there is provided a felt including the hybrid porous carbon fiber of the present disclosure.

In accordance with another aspect of the present disclosure, there is provided a supercapacitor including the hybrid porous carbon fiber of the present disclosure.

In accordance with another aspect of the present disclosure, there is provided an electrode for a fuel cell including the hybrid porous carbon fiber of the present disclosure.

In accordance with another aspect of the present disclosure, there is provided a method for fabricating a hybrid porous carbon fibers includes: mixing a starch solution, a carbon nanotube-dispersed solution and a spinning agent to obtain a spinning solution of carbon nanotube/starch/spinning agent; spinning the spinning solution to obtaining the starch fiber containing carbon nanotubes; and carbonizing the starch fiber containing carbon nanotubes, wherein the hybrid porous fiber contains mesopores having a pore diameter of from about 3 nm to about 10 nm, from about 3 nm to about 7 nm, or from about 3 nm to about 5 nm, and has a specific capacitance of about 150 F/g or more, about 170 F/g or more, but it is not limited thereto.

In accordance with an illustrative embodiment of the present disclosure, A weight ratio of the starch: the spinning agent is about 1: more than 0 to about 1, for examples, about 1: about 0.001, about 1: about 0.01, about 1: about 0.1, about 1: about 0.5, but it is not limited thereto. The spinning agent includes at least one selected from the group consisting of, but not limited to, polyvinyl alcohol, polyethylene oxide, polycarbonate, polylacetic acid, polyvinylcarbazole, polymethacrylate, cellulose acetate, collagen, polycaprolactone and poly(2-hydroxyethyl methacrylate).

In accordance with an illustrative embodiment of the present disclosure, the starch fiber containing carbon nanotubes is spun by electro-spinning or wet-state spinning the spinning solution.

In accordance with an illustrative embodiment of the present disclosure, the starch fiber containing carbon nanotubes is carbonized at from abut 500° C. to about 1,400° C. under vacuum or an inert gas atmosphere, but it is not limited thereto.

In accordance with an illustrative embodiment of the present disclosure, the method for fabricating a hybrid porous carbon fibers further includes heating the starch fiber containing carbon nanotubes at from about 150° C. to about 300° C., from about 170° C. to about 300° C., from about 200° C. to about 300° C., from about 250° C. to about 300° C., from about 150° C. to about 250° C., or from about 150° C. to about 200° C. to stabilize the starch fiber containing carbon nanotubes before the carbonization, but it is not limited thereto.

Hereinafter, examples of a hybrid porous carbon fiber and a method for fabricating the hybrid porous carbon fiber be explained in detail with reference to the accompanying drawings, but the present disclosure is not limited thereto.

### EXAMPLE 1

### Preparation of Starch Composite Fiber

After dissolving 2 g of starch in 30 ml of water, the solution was heated and boiled at 100 to 150° C. The heated starch was cooled to room temperature and stored in an incubator at a low temperature of 5° C. to prepare a gelled starch solution. Then, 0.2 mmol of p-toluenesulfonic acid as an organic acid was added to the gelled starch solution to obtain a starch solution.

Next, 0.02 g of carbon nanotubes and 0.02 g of NaDDBS (sodium dodecylbenzenesulfonate) as a dispersant were introduced to 20 ml of water, followed by ultrasonic treatment to prepare a homogeneous mixture.

Since starch has fiber formation resistance, a desired dispersant such as NaDDBS is required to fabricate starch composite fibers through the electro-spinning process.

Afterward, 2 g of polyvinyl alcohol (PVA) as the spinning agent was further added thereto to obtain a carbon nanotube/PVA solution.

Subsequently, the gelled starch solution was mixed with the above carbon nanotube/PVA solution to prepare a carbon nanotube/starch/PVA solution. This carbon nanotube/starch/PVA solution was found to have a viscosity in the range of 300 to 1,500 cP.

Finally, the resulting carbon nanotube/starch/PVA solution was charged in a syringe. High voltage (10 to 30 kV) was applied to the syringe, followed by spinning the same through spinning nozzles to produce starch composite fibers. A distance between the spinning nozzle and a spinneret ranges from 15 to 20 cm.

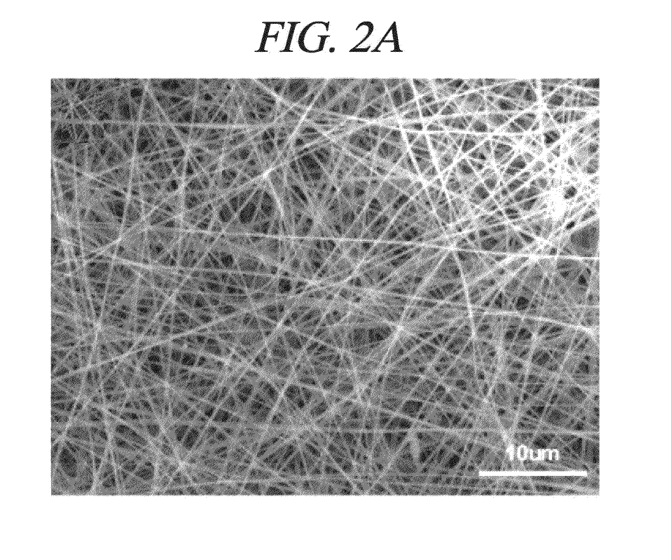

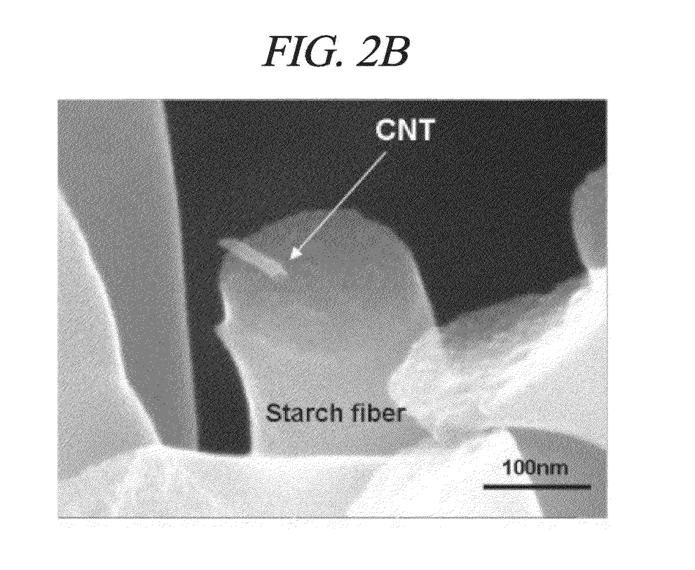

FIG. 2 shows SEM photographs of starch composite fibers fabricated as described above, especially, FIG. 2A is a SEM photograph of the fabricated starch composite fibers while FIG. 2B is an enlarged SEM photograph of one of the starch composite fibers shown in FIG. 2A.

### EXAMPLE 2

### Fabrication of Hybrid Porous Carbon Fiber

The starch composite fibers fabricated in Example 1 were stabilized by an oxidative heating process at 150 to 300° C. Then, the treated fibers were carbonized at 500 to 1,400° C. under vacuum or an inert gas atmosphere to produce porous carbon fibers.

Next, the prepared porous carbon fibers were subjected to vacuum-heat treatment at 1,400 to 2,200° C., finally resulting in porous carbon fibers with an average pore size of from 3 nm to 10 nm. The hybrid porous carbon fiber product obtained in the above temperature range was found to have a specific surface area ranging from 320 to 480 m²/g.

FIGS. 2A and 2B are a SEM photograph of porous carbon fibers having mesopores with a size of from 3 nm to 5 nm.

### EXAMPLE 3

### Preparation of MWCNTs

The MWCNTs (multi-walled carbon nanotubes) used in this study were the CVD-grown material produced at Iljin Co. The diameters of MWCNTs were about 20 nm with typical length of a few um. This sample was refluxed in 3 M nitric acid and stirred at 110° C. for 5 h to attach functional groups of carboxyl and hydroxyl groups. MWCNTs were then dried after rinsing by distilled water. Corn starch was used as carbon fiber precursor. Polyvinyl alcohol (PVA) was purchased from Aldrich Chemical.

Preparation of CNT/Carbon Nanofibers

The prepared MWCNT of 0.02 g was immersed in 20 ml of distilled water and sodium dodecyl sulfate (SDS) was also added for MWCNT to disperse in homogeneously. The MWCNT solution was sonicated for 3 h in a bath-type sonicator (Hwashin Technology Co. 520 W). MWCNTs were homogeneously dispersed and stable having a dark ink-like appearance without being precipitated for several hours. PVA of 0.67 g was dissolved in 10 ml of distilled water and stirred vigorously at 80° C. and MWCNT solution was added into PVA solution. PVA was used as spinning agent because starch itself cannot be electrospun into fibrous structure. Starch of 2 g was then dissolved in 30 ml of distilled water and stirred vigorously at 50° C. The starch solution was boiled at 120° C. for an hour and cooled to room temperature. Finally, the MWCNT/PVA solution and starch solution were mixed and maintained for a day.

This MWCNT/starch/PVA solution was used for electrospinning. A power supply (CPS-60K02VIT, CHUNGPA, Korea) with variable high voltage (maximum voltage of 60 kV) was used for the electrospinning process. The electrospun fiber was collected by attaching it to the aluminum foil wrapped on a metal drum with a diameter of 15 cm rotating at 1000 rpm. The bias voltage was fixed at 18 kV. The carbonization of the MWCNT/starch/PVA nanofiber web was performed in a vacuum furnace. The electrospun fiber web was stabilized at 250° C. with a ramping rate of 1° C./min for 1 h in air and then carbonization was performed at 500, 700, 1000, 1300, and 1400° C., respectively, with a ramping rate of 2° C. min⁻¹ for 1 h under vacuum.

### Test Example

The nanofiber morphology was analyzed by using scanning electron micrograph (SEM: XL-305, Philips) and transmission electron microscopy (TEM: Tecnai 20F). The carbon content was analyzed by elemental analysis (EA). The transition from amorphous carbon to graphitic was characterized by XRD (D/MAX-IIIC. 3 kW). The functional groups of CNT/carbon nanofibers were studied by FT-IR analysis (FT-Raman, Bruker, Germany). Specific surface and pore size distribution of our samples were characterized by using the Brunauer-Emmett-Teller equation (Tristar3000, Micromeritics, USA). The cyclic voltammetry of CNT/carbon nanofibers electrode without binders or conductive materials were performed in 1 M H₂SO₄ solution to evaluate the capacitance at the condition of the potential range 0-0.5 V and the scan rate 10 mV s⁻¹.

Morphology of CNT/Starch/PVA Nanofiber

To obtain mesoporous carbon materials without using template method, natural polymer, starch was used. Starch has a natural ability to assemble into a nanoscale lamellar structure consisting of crystalline and amorphous regions (FIG. 1A). J. H. Clark et al. revealed that starch can be converted into mesoporous carbonaceous material with an average pore carbon nanofiber web can provide high surface area, easy access of ions, and binder-free electrode due to its free-standing shape. Embedded or protruded CNTs act as a strong reinforcement and high conductive path to enhance the mechanical and electrical properties of mesoporous carbon nanofibers.

Electrospinning is a powerful tool for fabricating thin and flexible organic nanofiber webs through an electrically charged jet of polymer solution or polymer melt. One of the important features of electrospinning is that suitable solvent should be available for dissolving the polymer. When native starch granules are exposed to water vapor or liquid water, they absorb water and undergo limited, reversible swelling. Heating starch containing limited water results in melting of the starch crystallites and the melting temperature depends on the moisture content. With excess water, melting over 100° C. is accompanied by hydration and profound irreversible swelling over: the collective process is known as gelatinization. This process is necessary for preparing gelatinized starch which produces mesoporous materials when it is carbonized. However, gelatinized starch cannot be electrospun within water solvent. Thus, polyvinylalcohol (PVA) as a spinning agent was introduced to the fabrication process. With the aid of spinning agent, gelatinized starch was firstly electrospun in water solvent into a web with large area (10 cm×10 cm). The colour of fabricated web was light-grey due to adding small amounts of CNTs. The morphology of electrospun starch nanofibers had straight shape with smooth surface and no defects or beads were found in all areas of the web as shown in FIG. 2A. The individual starch nanofiber showed cylindrical shape with a diameter of ca. 150 nm. CNTs were successfully implanted within a starch nanofiber forming like a candle wick as shown by the scanning electron microscopy image in FIG. 2B. The networking of CNTs within a starch nanofiber shown by the transmission electron microscopy in FIG. 2A demonstrates that CNTs embedded within starch nanofibers can act as a conductive path and contribute to enhance the electrical conductivity of the final mesoporous carbon nanofibers as we expected.

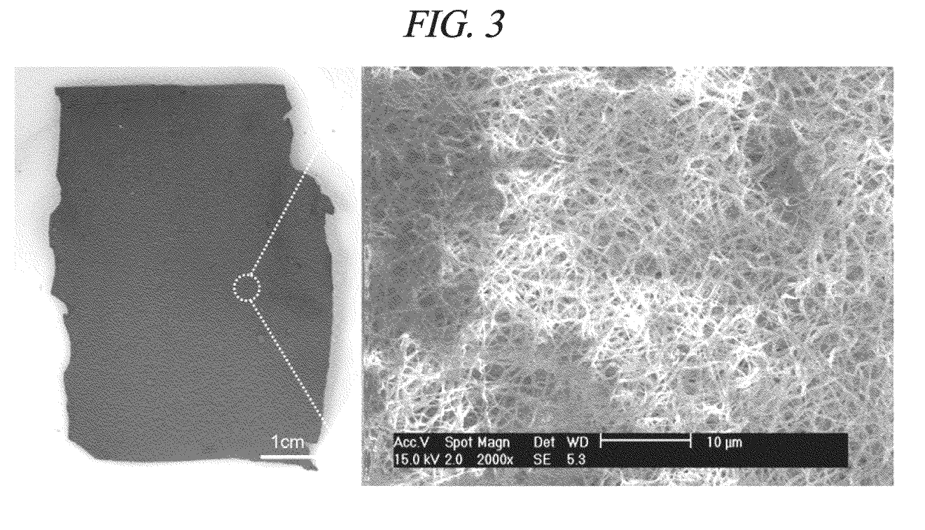

Before the organic fibers are carbonized, chemical alteration is necessary to convert their linear atomic bonding to a more thermally stable ladder bonding not to collapse their fiber morphology. In general, this is accomplished by heating the fibers in the air to about 200˜300° C. This causes the fibers to pick up the oxygen molecules from the air and rearrange their atomic bonding pattern. Therefore, the electrospun starch nanofibers were stabilized at 250° C. for 1 h in air environment to maintain their fibrous morphology during high-temperature thermal treatment. After oxidative stabilization, the light-grey-coloured web changed into brown-coloured one. In addition, the stabilized web was downsized and the starch nanofibers became curlier and more corrugated owing to shrinkage of the porous web during heat treatment without collapsing their fibrous morphology (See FIG. 3).

Effect of Thermal Treatment on CNT/Carbon Nanofibers

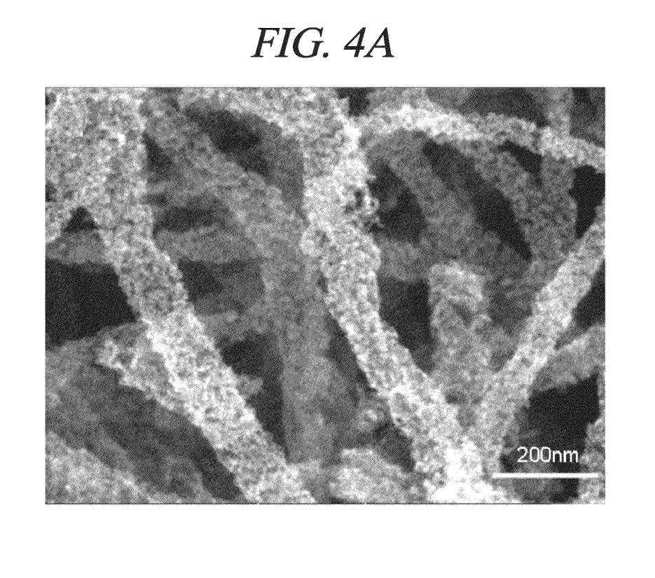

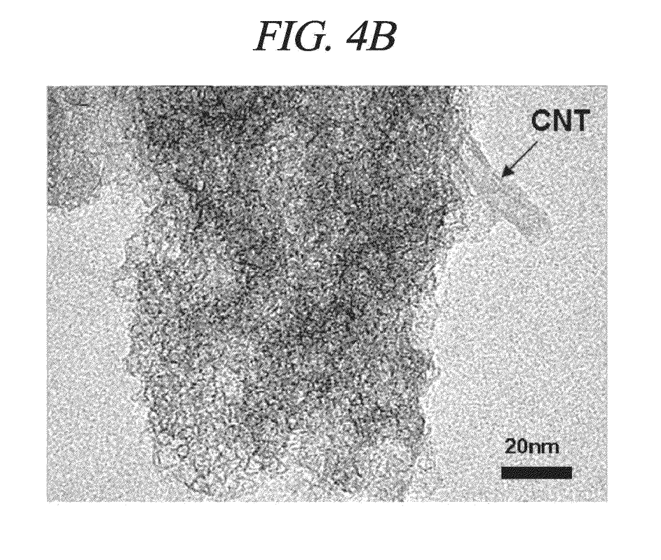

Once the nanofibers are stabilized, they were heated to a temperature of 700, 1300, and 1400° C. in vacuum (10⁻⁶ torr). The carbon content of starch nanofibers carbonized at each temperature was over 90% above 700° C. thermal treatment (Table 1). From the result, we can notice that starch nanofibers were successfully converted into carbon nanofibers over 700° C. thermal treatment. Interestingly, the carbon nanofibers heat-treated at 1400° C. had highly porous surface as shown by the scanning electron microscopy and transmission electron microscopy in FIGS. 4A and 4B. This highly porous structure is caused from the natural ability of starch. The starch consists of two types of molecules: the linear and helical amylose and the branched amylopectin. In the native form of starch, amylose and amylopectin molecules are organized in granules as alternating semi-crystalline and amorphous layers that form growth rings as illustrated in FIG. 1A. The semi-crystalline layer consists of ordered regions composed of double helices formed by short amylopectin branches, most of which are further ordered into crystalline structures known as the crystalline lamellae. The amorphous regions of the semi-crystalline layers and the amorphous layers are composed of amylose and non-ordered amylopectin branches. This peculiar nanoscale lamellar structure of starch alternating between amorphous amylose and crystalline amylopectin makes it possible to form porous carbon structure by converted into an ordered porous structure after they were heat-treated over 1,400° C.

TABLE
Elemental analysis of the electrospun, air-
stabilized, and carbonized nanofibers

| | Temp. | Carbon | Nitrogen | Hydrogen | Sulfur |
|---|---|---|---|---|---|
| I.D. | [° C.] | [%] | [%] | [%] | [%] |
| Electrospinning | RT | 51.61 | 0.213 | 8.3 | 1.533 |
| Air-stabilization | 250 | 62.54 | 0.0328 | 2.04 | 0.785 |
| Carbonization | 500 | 80.97 | 0.368 | 1.921 | 0.344 |
| | 700 | 92.81 | 0.335 | 0.738 | 0.252 |
| | 1,000 | 92.41 | 0.417 | 0.989 | 0.000 |
| | 1400 | 95.09 | 0.699 | 0.115 | 0.048 |

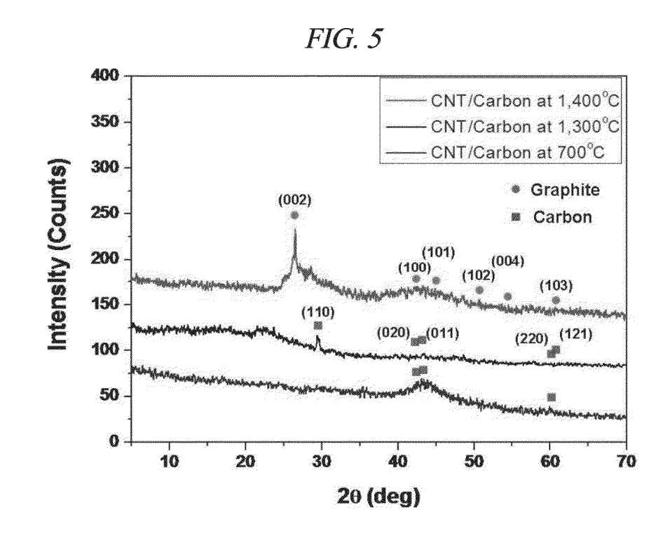

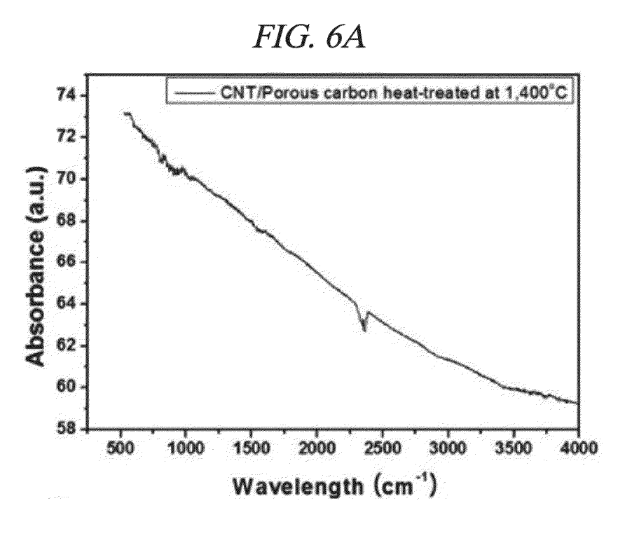

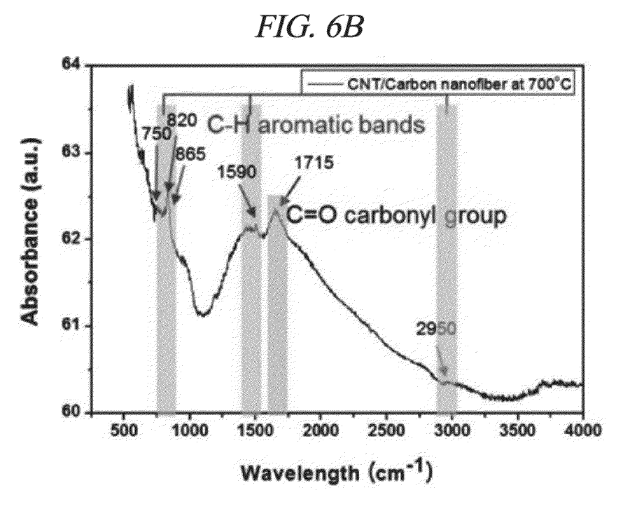

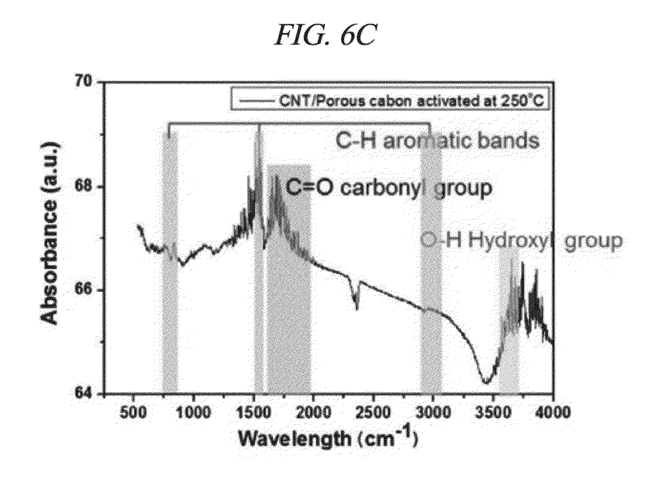

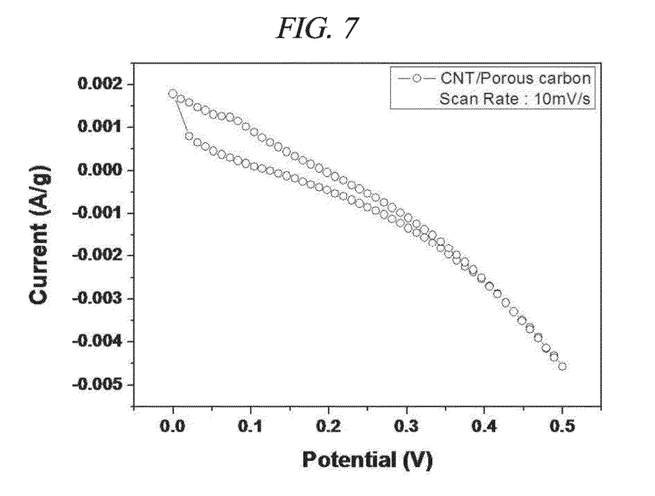

This highly porous carbon nanofiber structure is the first report besides the template method. Generally, in case of coal, pitch, wood, coconut shells, or polymers such as polyacrylonitrile, micrographitization can occur and some surface or edge functional groups are dissociatively distilled or pyrolyzed off in the pre-treatment of activation procedures at 2,000° C.˜2,800° C. and consequently they have most of micropores on their surfaces. In case of starch, graphitization starts from 1,400° C. as shown by XRD analysis (FIG. 5) and we can notice that the intensity of all aromatic C—H bands (750, 820, 865, and 1,590 cm⁻¹) and carbonyl C═O bands (1,715 cm⁻¹) of porous carbon nanofibers heat-treated at 1,400° C. decreases or disappears compared with functional groups of CNT/carbon nanofibers heat-treated at 700° C. as shown in FIGS. 6A and 6B. From those results, we can infer that carbon nanofibers heat-treated at 1400° C. originated by starch get highly porous structure due to the dissociation and pyrolysis of functional groups by graphitization. However, because these highly porous CNT/carbon nanofibers have no functional groups such as aromatic and carbonyl bands on their surface as we mentioned before and hydrophobicity, they showed abnormal electrochemical properties (FIG. 7). Therefore, we made this highly porous CNT/carbon nanofibers activated at 250° C. in air environment to functionalize their surfaces. As a result, CNT/porous carbon nanofibers were activated with various functional groups such as C-H aromatic bands, C═O carbonyl groups and O—H hydroxyl groups as shown in FIG. 6C.

Electrochemical Characterization of CNT/Carbon Nanofibers

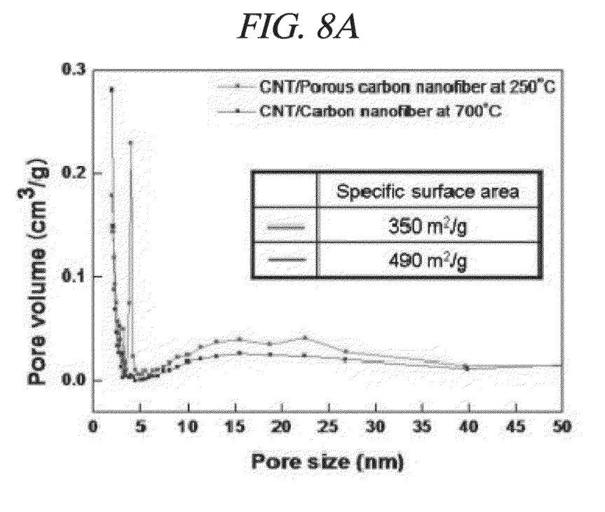

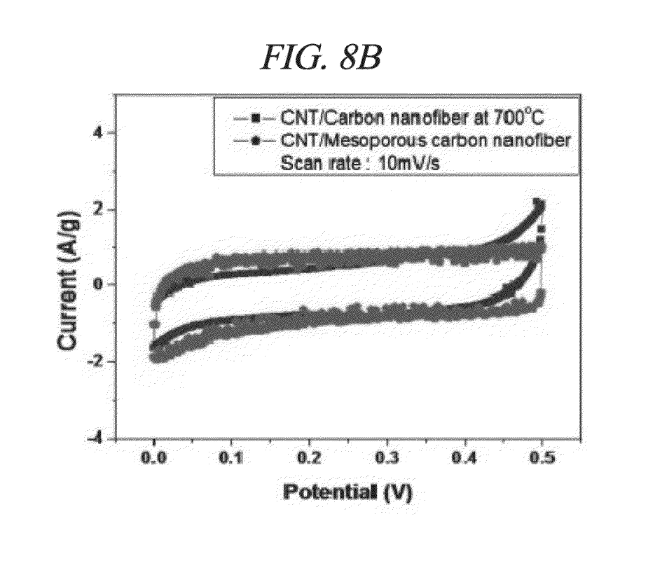

The specific surface area (SSA) and pore size distribution of the CNT/carbon nanofibers heat-treated at 700° C. and porous CNT/carbon nanofibers activated at 250° C. were characterized from the analysis of nitrogen adsorption/desorption isotherms at 77 K using density function theory. Each sample was covered as high as 490 and 350 m² g⁻² of the BET surface area. The pore size distribution of CNT/carbon nanofibers heat-treated at 700° C. indicates that it consists of most of micropores with the pore volume of 0.33 cm³ g⁻¹, whereas one of porous CNT/carbon nanofibers activated at 250° C. indicates a predominance of mesopores (4.76 nm) with the pore volume of 0.31 cm³ g⁻¹ and the porous distribution exhibits predominantly bimodal of the mesopore region as shown in FIG. 8A. from the above analysis, we can notice that the highly porous CNT/carbon nanofibers have mesopores with diameter of 4.76 nm on their surface as expected in a schematic of our final goal structure.

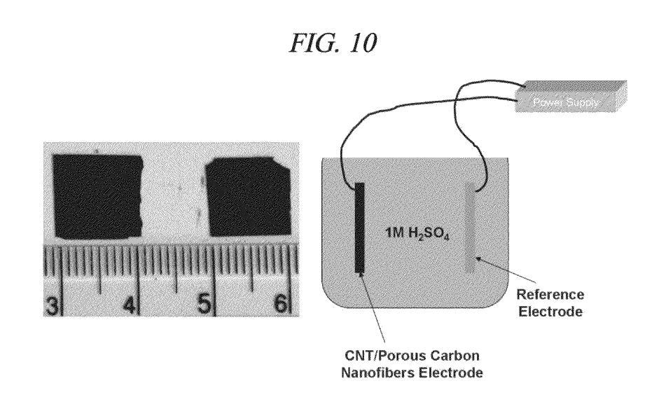

The final black-coloured web was cut into a rectangular shape (1 cm×1 cm) and characterized its specific capacitance without binder using 1 M H₂SO₄ as the electrolyte (FIG. 10). The electrical conductivity was calculated by following equation;

σ=L/(AR)

wherein R is electrical resistance in Ω, A is the cross-sectional area in cm², and L is distance between electrodes in cm. The electrical conductivity of CNT/carbon nanofibers electrode heat-treated at 700° C. and porous CNT/carbon nanofibers electrode activated at 250° C. was as high as 1.068 S cm⁻¹ and 2.137 S cm⁻¹ respectively. About 2 times-increase of the electrical conductivity at the latter is due to the transition of amorphous into graphitic structure as shown in XRD analysis mentioned before.

Electrochemical properties of CNT/carbon nanofibers electrode heat-treated at 700° C. and porous CNT/carbon nanofibers electrode activated at 250° C. are shown in FIG. 8B. The cyclic voltammetry (CV) tests were recorded in the potential range between 0 and 0.5 V. The CV curve at 10 mV s⁻¹ of the former shows a little deviation from the ideal rectangular-shape, but has high specific capacitance of 132 F due to the high specific surface area of 490 m² g⁻¹ and high electrical conductivity. This deviation can come from the side reaction of its functional groups such as hydrogen and oxygen as shown in FIG. 6A. On the other hand, the CV curve of the latter has very small fluctuation due to its functional groups which interact with ions in the electrolyte, but it has a good rectangular shape owing to its mesoporous structure which has good ion accessibility and abundant pore distributions at effective pore sizes of 4.76 nm and higher specific capacitance of 170 F g⁻¹ than the former. This specific capacitance indicates a highly capacitive nature with good ion accessibility with higher value than other carbon fibers derived from polyacrylonitrile (140 F g⁻¹) and CNT/carbon fibers derived from polyacrylonitrile (100 F g⁻¹).

In summary, starch was firstly electrospun into the starch nanofibers with diameters ranging from 150 nm to 200 nm with the aid of spinning agent (PVA) and used as a carbon source material of the electrochemical capacitor electrode. By using the natural ability of starch lamellar structure and controlling the carbonization temperature, the present inventors successfully fabricated binder-free electrochemical capacitor electrode material consisting of highly mesoporous carbon nanofibers reinforced with CNTs with higher specific capacitance (170 F g⁻¹) and electrical conductivity (2.1 S cm⁻¹) than other carbon electrodes derived from synthetic polymers and free-standing CNT electrodes. The high specific capacitance of highly mesoporous carbon nanofibers electrode reinforced with CNTs comes from the high specific surface area and the sufficient pore distributions at the effective mesoporous sizes of 3˜5 nm. In addition, transitions between amorphous and graphitic structures occurred at high temperature (1,400° C.) and CNT networking within the carbon nanofibers lead to increase the electrical conductivity of our newly developed electrode material.

Thereby, the research reveals that starch which has advantages in aspects of low cost and environmental-friendly material is an ideal material as the carbon source of electrochemical capacitor electrode and can provide a simple and cheap approach for the fabrication of binder-free electrochemical capacitor electrode. In the future, it is also expected to see further incorporation of designed mesoporous carbon nanofibers web into fuel cell electrode, catalysis, and hydrogen storage.

### EXAMPLE 4

### Fabrication of Porous Carbon Fiber Coated with Pt Nanoparticles

A felt made of the porous carbon fibers fabricated in Example 2 was cut in a dimension of 1 cm×1 cm and subjected to sputtering of Pt nanoparticles. As a result, porous carbon fibers coated with Pt nanoparticles were obtained.

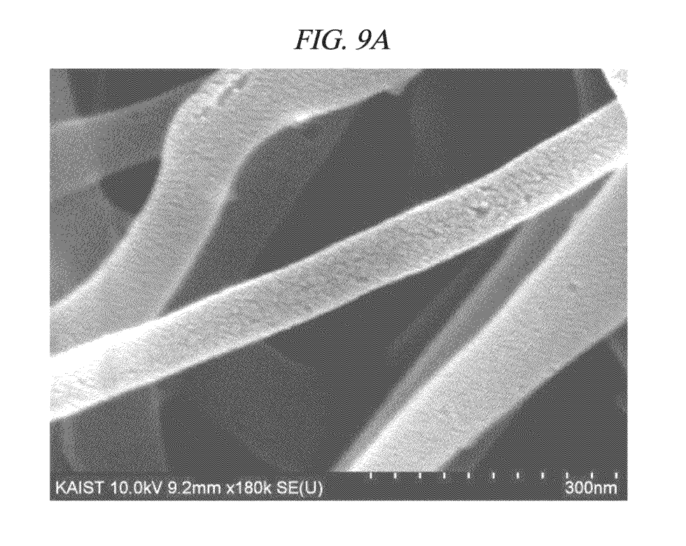

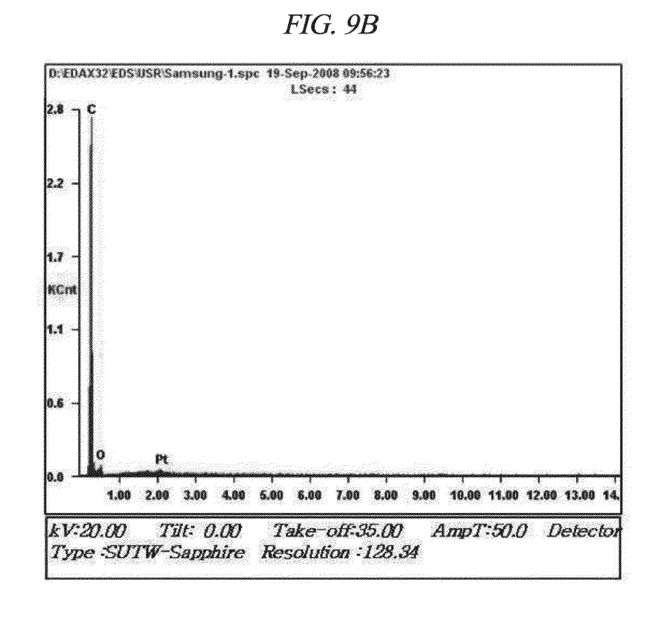

FIG. 9A is a SEM photograph of porous carbon fibers coated with Pt nanoparticles, which were fabricated in Example 4, and FIG. 9B illustrates EDAX analysis results of the same. From the EDAX results shown in FIG. 5B, it can be seen that the surface of the carbon fiber was coated with Pt nanoparticles.

Although an electro-spinning process was used in the above example, it is of course possible to adopt a wet-state spinning process in place of the electro-spinning process.

While the present disclosure has been described with reference to preferred embodiments, it will be understood by those skilled in the art that various modifications and variations may be made therein without departing from the scope of the present disclosure as defined by the appended claims.

As is apparent from the above disclosure, the present disclosure provides porous carbon fibers fabricated using fiber formation resistant starch. Comparing to a conventional technique, which uses fiber formable polymer such as PAN or pitch based polymer in fabricating carbon fibers, the porous carbon fibers of the present disclosure exhibit excellent electro-chemical properties including high capacitance, as well as high specific surface area.

Briefly, the present disclosure provides a method for fabrication of carbon fibers from starch through electro-spinning or wet-state spinning wherein the starch is an eco-friendly and economically advantageous natural polymer having fiber formation resistance. The inventive method may produce porous carbon fibers containing a great amount of mesopores having an average diameter of from about 3 nm to about 10 nm by controlling carbonization. Consequently, the porous carbon fibers fabricated by the present disclosure may overcome conventional limitations of existing activated carbon fibers having micropores of less than 1 nm in large amount, which seldom allow penetration of electrolyte.

In addition, the porous carbon fibers of the present disclosure may be used in a wide range of applications including, for example, fuel cell electrodes as well as electrodes for supercapacitors requiring high specific surface area and high electric conductivity, thereby exhibiting considerably improved industrial applicability.

The examples are provided to explain the present disclosure, but the present disclosure is not limited to the above-described examples and can be modified in various ways. It is clear that the present disclosure can be modified in various ways by those skilled in the art within a scope of the present disclosure.

What is claimed is:

1. A hybrid porous carbon fiber comprising carbon nanotube-reinforced carbon nanofiber, which contains mesopores having a pore diameter of from about 3 nm to about 10 nm, and has a specific capacitance of about 150 F/g or more.

2. The hybrid porous carbon fiber of claim 1, wherein the hybrid porous fiber has a specific surface area of from about 300 m²/g to about 500 m²/g, and an electrical conductivity of from about 1 S/cm to about 3 S/cm.

3. The hybrid porous carbon fiber of claim 1, wherein the hybrid porous fiber is prepared by carbonizing a starch fiber containing carbon nanotubes.

4. The hybrid porous carbon fiber of claim 3, wherein the starch fiber containing carbon nanotubes is prepared by mixing a starch solution, a carbon nanotube-dispersed solution and a spinning agent to obtain a spinning solution of carbon nanotube/starch/spinning agent, and spinning the spinning solution to obtain the starch fiber containing carbon nanotubes.

5. The hybrid porous carbon fiber of claim 4, wherein the spinning agent contains at least one selected from the group consisting of polyvinyl alcohol, polyethylene oxide, polycarbonate, polylacetic acid, polyvinylcarbazole, polymethacrylate, cellulose acetate, collagen, polycaprolactone, and poly(2-hydroxyethyl methacrylate).

6. The hybrid porous carbon fiber of claim 4, wherein a weight ratio of the starch: the spinning agent is about 1: more than 0 to about 1.

7. The hybrid porous carbon fiber of claim 4, wherein the starch fiber containing carbon nanotubes is spun by electro-spinning or wet-state spinning the spinning solution.

8. A felt comprising the hybrid porous carbon fiber of claim 1.

9. A supercapacitor comprising the hybrid carbon porous fiber of claim 1.

10. An electrode for a fuel cell comprising the hybrid porous carbon fiber of claim 1.

11. A method for fabricating a hybrid porous carbon fibers comprising
mixing a starch solution, a carbon nanotube-dispersed solution and a spinning agent to obtain a spinning solution of carbon nanotube/starch/spinning agent;
spinning the spinning solution to obtaining the starch fiber containing carbon nanotubes; and
carbonizing the starch fiber containing carbon nanotubes,
wherein the hybrid porous fiber contains mesopores having a pore diameter of from about 3 nm to about 10 nm, and has a specific capacitance of about 150 F/g or more.

12. The method of claim 11, wherein the starch fiber containing carbon nanotubes is spun by electro-spinning or wet-state spinning the spinning solution.

13. The method of claim 11, wherein the spinning agent includes at least one selected from the group consisting of polyvinyl alcohol, polyethylene oxide, polycarbonate, polylacetic acid, polyvinylcarbazole, polymethacrylate, cellulose acetate, collagen, polycaprolactone and poly(2-hydroxyethyl methacrylate).

14. The method of claim 11, wherein a weight ratio of the starch: the spinning agent is about 1: more than 0 to about 1.

15. The method of claim 11, wherein the starch fiber containing carbon nanotubes is carbonized at from about 500° C. to about 1,400° C. under vacuum or an inert gas atmosphere.

16. The method of claim 11, further comprising
heating the starch fiber containing carbon nanotubes at from about 150° C. to about 300° C. to stabilize the starch fiber containing carbon nanotubes before the carbonization.
